(19) United States
(12) Patent Application Publication
(10) Pub. No.: US 2024/0291676 A1
(43) Pub. Date: Aug. 29, 2024

(54) ELECTRONIC DEVICE FOR PROVIDING INTERNET OF THINGS SERVICE AND METHOD FOR OPERATION THEREOF

(71) Applicant: SAMSUNG ELECTRONICS CO.,LTD., Suwon-si (KR)

(72) Inventors: Jaewoo SEO, Suwon-si (KR); Hyunwoo KIM, Suwon-si (KR); Seongwon HAN, Suwon-si (KR); Jeongyoon HEO, Suwon-si (KR); Choonghoon LEE, Suwon-si (KR); Jungil CHO, Suwon-si (KR)

(73) Assignee: SAMSUNG ELECTRONICS CO.,LTD., Suwon-si (KR)

(21) Appl. No.: 18/434,353

(22) Filed: Feb. 6, 2024

Related U.S. Application Data
(63) Continuation of application No. PCT/KR24/00680, filed on Jan. 15, 2024.

(30) Foreign Application Priority Data
Feb. 27, 2023 (KR) 10-2023-0025963

(51) Int. Cl. H04L 9/40; G16Y 40/10

(52) U.S. Cl. CPC H04L 9/40; G16Y 40/10

(57) ABSTRACT

An electronic device includes memory storing instructions, a communication circuit, and a processor. The instructions that cause the electronic device to: obtain state information collected by at least one first Internet of Things (IoT) device and sound information comprising an amplitude of at least one sound signal collected by at least one second IoT device, perform first anomaly monitoring, based on a correlation between the state information and the sound information, and perform second anomaly monitoring, based on the state information.

### CROSS-REFERENCE TO RELATED APPLICATIONS

This application is a by-pass continuation application of International Application No. PCT/KR2024/000680, filed on Jan. 15, 2024, which is based on and claims priority to Korean Patent Application No. 10-2023-0025963, filed on Feb. 27, 2023, in the Korean Intellectual Property Office, the disclosures of which are incorporated by reference herein their entireties.

### BACKGROUND

### 1. Field

The disclosure relates to an electronic device for providing an Internet of Things (IoT) service and an operation method thereof.

### 2. Description of Related Art

An increasing number of various services and additional functions are provided through electronic devices, such as user terminals, in particular, smartphones. To increase usefulness of the electronic devices and satisfy various user demands, communication service providers or electronic device manufacturers have competitively developed the electronic devices that provide various functions. Accordingly, various functions provided through the electronic devices become increasingly sophisticated.

As wireless communication technology develops, devices using artificial intelligence (AI) are widely introduced. For example, home appliances that are connected to a network via Internet of Things (IoT) technology may use AI-based technologies. IoT technology may provide an intelligent Internet technology service that collects and analyzes data generated from the electronic devices to create new value in human lives. IoT technology is applicable to, for example, smart homes, smart buildings, smart cities, smart cars, and smart home appliances, through various convergences and combinations of existing Internet technology and various industries.

Homes have various home appliances and services for facilitating operations. IoT technologies are proposed to control home appliances. Home network technology may provide various services to users at home through a home network. For example, the users may control devices (e.g., home appliances to which IoT technology is applied) forming the home network by using the user terminals (e.g., a smartphone). The users may receive various services through the controlled devices.

### SUMMARY

Embodiments of the disclosure may detect an abnormal event of a network system.

Provided is an electronic device for detecting an abnormal situation of a network by using sound information and an operation method thereof.

Provided is an electronic device for detecting an abnormality of a network by comparing state information and sound information collected by IoT devices and an operation method thereof.

Technical aspects to be achieved in the disclosure are not limited to the technical aspects mentioned above, and other technical aspects not mentioned will be clearly understood by those skilled in the art to which the disclosure pertain from the following description.

According to an aspect of the disclosure, an electronic device may include: memory storing instructions, a communication circuit, and a processor operatively connected with the memory and the communication circuit and configured to execute the instructions. The instructions may cause the electronic device to obtain state information collected by at least one first Internet of Things (IoT) device and sound information comprising an amplitude of at least one sound signal collected by at least one second IoT device. The instructions may cause the electronic device to perform first anomaly monitoring, based on a correlation between the state information and the sound information. The instructions may cause the electronic device to perform second anomaly monitoring, based on the state information.

According to an aspect of the disclosure, a method performed by an electronic device, may include obtaining state information collected by at least one first Internet of Things (IoT) device and sound information comprising an amplitude of at least one sound signal collected by at least one second IoT device. The method may include performing first anomaly monitoring, based on a correlation between the state information and the sound information. The method may include performing second anomaly monitoring, based on the state information.

According to an aspect of the disclosure, a non-transitory computer-readable recording medium may store one or more programs, and the one or more programs may include instructions that, when executed by a processor of an electronic device, cause the electronic device to obtain state information collected by at least one first IoT device and sound information including an amplitude of at least one sound signal collected by at least one second IoT device, to perform first anomaly monitoring, based on a correlation between the state information and the sound information, and to perform second anomaly monitoring, based on the state information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an Internet of Things (IoT) system according to an embodiment;

FIG. 2 is a block diagram of an electronic device in a network environment according to some embodiments;

FIG. 3 illustrates a network including IoT devices according to an embodiment;

FIG. 4A is a block diagram illustrating a configuration of a hub device according to an embodiment;

FIG. 4B is a block diagram illustrating a configuration of a server according to an embodiment;

FIG. 5 is a flowchart illustrating a procedure of performing sound-based anomaly monitoring according to an embodiment;

FIG. 6 illustrates collection of state information and sound information according to an embodiment;

FIG. 7A and FIG. 7B illustrate sound-based anomaly monitoring according to embodiments;

FIG. 8 is a flowchart illustrating a reporting procedure of a hub device according to an embodiment;

FIG. 9 is a flowchart illustrating an anomaly monitoring procedure of a server according to an embodiment; and

FIG. 10 and FIG. 11 are flowcharts illustrating sound-based anomaly monitoring procedures according to embodiments.

### DETAILED DESCRIPTION

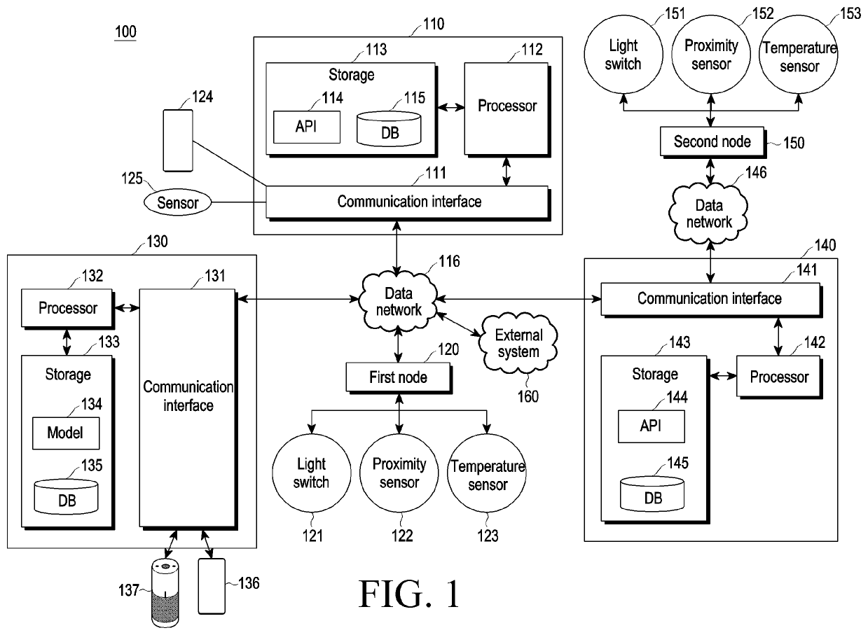

FIG. 1 illustrates an Internet of Things (IoT) system 100 according to an embodiment. At least some of components of FIG. 1 may be omitted, and components not shown may be further included.

Referring to FIG. 1, the IoT system 100 according to the embodiment may include a plurality of electronic devices connectable to a data network 116 or 146. For example, the IoT system 100 may include at least one of a first IoT server 110, a first node 120, a (voice assistant) server 130, a second IoT server 140, a second node 150, or devices (e.g., a light switch 121, a proximity sensor 122, a temperature sensor 123, a mobile phone 124, a sensor 125, a mobile phone 136, a hub 137, a light switch 151, a proximity sensor 152, and a temperature sensor 153).

According to an embodiment, the first IoT server 110 may include at least one of a communication interface 111, a processor 112, or a storage 113. The second IoT server 140 may include at least one of a communication interface 141, a processor 142, and a storage 143. An “IoT server” disclosed herein may remotely control or monitor one or more devices (e.g., the devices 121, 122, 123, 124, 125, 151, 152, and 153) through a relay device (e.g., the first node 120 or the second node 150) or directly without a relay device, based on a data network (e.g., the data network 116 or the data network 146).

A “device” disclosed herein is, for example, a sensor, a home appliance, an office electronic device, or a device for performing a process that is disposed (or located) in a local environment, such as a house, an office, a factory, a building, an external place, or other types of properties, and is not limited to a specific type. A device that receives a control command and performs an operation corresponding to the control command may be referred to as a “target device”. The IoT server may be referred to as a central server in that the IoT server is configured to select the target device from among a plurality of devices and to provide a control command.

According to an embodiment, the first IoT server 110 may communicate with devices 121, 122, and 123 through the data network 116. The data network 116 may refer to a network for long-distance communication, such as the Internet or a computer network (e.g., a LAN or WAN), or may include a cellular network.

According to an embodiment, the first IoT server 110 may be connected to the data network 116 through the communication interface 111. The communication interface 111 may include a communication device (or a communication module) for supporting communication of the data network 116, and may be configured as one integrated component (e.g., a single chip) or may be configured with a plurality of separate components (e.g., a plurality of chips). The first IoT server 110 may communicate with the devices 121, 122, and 123 through the first node 120. The first node 120 may receive data from the first IoT server 110 through the data network 116, and may transmit the received data to at least some of the devices 121, 122, and 123. Alternatively, the first node 120 may receive data from at least some of the devices 121, 122, and 123, and may transmit the received data to the first IoT server 110 through the data network 116. The first node 120 may function as a bridge between the data network 116 and the devices 121, 122, and 123. Although FIG. 1 shows one first node 120, which is only for illustration, the number of first nodes is not limited.

A “node” disclosed herein may be an edge computing system or a hub device. According to an embodiment, the first node 120 may support wired and/or wireless communication of the data network 116, and may also support wired and/or wireless communication with the devices 121, 122, and 123. For example, the first node 120 may be connected to the devices 121, 122, and 123 via a short-range communication network, such as at least one of Bluetooth, Wi-Fi, Wi-Fi Direct, Z-Wave, ZigBee, INSETEON, X10, or infrared data association (IrDA), but is not limited to a specific communication type. The first node 120 may be disposed (or located) in an environment, such as a house, an office, a factory, a building, an external place, or other types of properties. Accordingly, the devices 121, 122, and 123 may be monitored and/or controlled by a service provided by the first IoT server 110, and the devices 121, 122, and 123 may not be required to have a capability of complete network communication (e.g., Internet communication) for direct connection to the IoT server 110. The devices 121, 122, and 123 are shown as being configured as an electronic device in a home environment, for example, a light switch, a proximity sensor, and a temperature sensor, which is for illustration, and are not limited.

According to an embodiment, the first IoT server 110 may support direct communication with devices 124 and 125. Here, “direct communication” is communication not through a relay device, for example, the first node 120, and may refer to, for example, communication through a cellular communication network and/or a data network.

According to an embodiment, the first IoT server 110 may transmit a control command to at least some of the devices 121, 122, 123, 124, and 125. Here, a “control command” may refer to data to cause a controllable device to perform a specific operation, and the specific operation may be an operation performed by a device, and may include outputting information, sensing information, reporting information, or managing (e.g., deleting or generating) information, without being limited to a type. For example, the processor 112 may obtain information (or a request) for generating a control command from the outside (e.g., the (voice assistant) server 130, the second IoT server 140, an external system 160, or at least some of the devices 121, 122, 123, 124, and 125), and may generate a control command, based on the obtained information. Alternatively, the processor 112 may generate a control command, based on the result of monitoring at least some of the devices 121, 122, 123, 124, and 125 satisfying a designated condition. The processor 112 may control the communication interface 111 to transmit a control command to a target device.

According to an embodiment, the processor 112, a processor 132, or the processor 142 may be configured as a combination of one or more of a general-purpose processor, such as a central processing unit (CPU), a digital signal processor (DSP), an application processor (AP), or a communication processor (CP), a graphics-dedicated processor, such as a graphics processing unit (GPU) or a vision processing unit (VPU), or an artificial intelligence-dedicated processor, such as a neural processing unit (NPU). The foregoing processing units are merely for illustration, and those skilled in the art will understand that the processor 112 is not limited as long as the processor 112 is an operational device capable of executing an instruction stored in the storage 113 and outputting the execution result.

According to an embodiment, the processor 112 may configure a web-based interface, based on an API 114, or may expose a resource managed by the first IoT server 110 to the outside. The web-based interface may support, for example, communication between the first IoT server 110 and an external web service. The processor 112 may allow, for example, the external system 160 to control and/or access the devices 121, 122, and 123. The external system 160 may be, for example, an independent system that is not associated with the system 100 or is not part of the system 100. The external system 160 may be, for example, an external server or a website. However, security is required for access to the devices 121, 122, and 123 or a resource of the first IoT server 110 from the external system 160. According to an embodiment, the processor 112 may expose an API endpoint (e.g., a universal resource locator (URL)) based on the API 114 to the outside using an automation application. As described above, the first IoT server 110 may transmit a control command to a target device among the devices 121, 122, and 123. A description of the communication interface 141, the processor 142, and an API 144 and a database 145 of the storage 143 of the second IoT server 140 is substantially the same as that of the communication interface 111, the processor 112, and the API 114 and a database 115 of the storage 113 of the first IoT server 110. Further, a description of the second node 150 may be substantially the same as that is the first node 120. The second IoT server 140 may transmit a control command to a target device among devices 151, 152, and 153. The first IoT server 110 and the second IoT server 140 may be operated by the same service provider in an embodiment, but may be operated by different service providers in another embodiment.

According to an embodiment, the (voice assistant) server 130 may transmit and receive data to and from the first IoT server 110 through the data network 116. According to an embodiment, the (voice assistant) server 130 may include at least one of a communication interface 131, a processor 132, and a storage 133. The communication interface 131 may communicate with a smartphone 136 or an AI speaker 137 through a data network (not shown) and/or a cellular network (not shown). The smartphone 136 or the AI speaker 137 may include a microphone, and may obtain a user voice, may convert the user voice into a voice signal, and may transmit the voice signal to the (voice assistant) server 130. The processor 132 may receive the voice signal from the smartphone 136 or the AI speaker 137 through the communication interface 131. The processor 132 may process the received voice signal, based on a stored model 134. The processor 132 may generate (or identify) a control command using the processing result, based on information stored in the database 135. According to an embodiment, the storage 113, 133, and 143 may include at least one type of a non-transitory storage medium among a flash memory type, a hard disk type, a multimedia card micro type, a card-type memory (e.g., SD or XD memory), random access memory (RAM), a static random access memory (SRAM), read-only memory (ROM), electrically erasable programmable read-only memory (EEPROM), programmable read-only memory (PROM), magnetic memory, a magnetic disk, and an optical disk, and is not limited to a type.

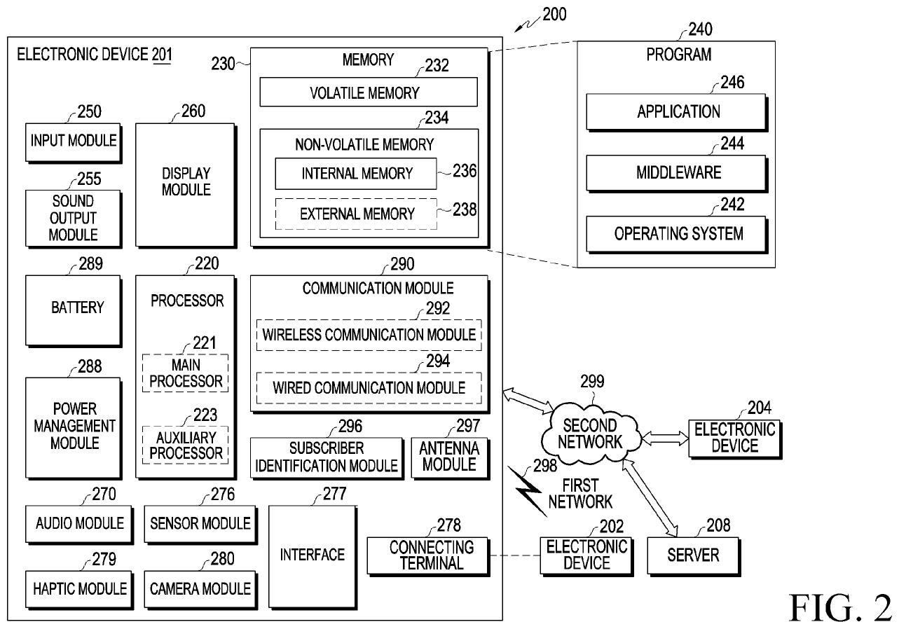

In an embodiment, at least one device (e.g., the device 124) communicating with the first IoT server 110 may be an electronic device (e.g., an electronic device 201 of FIG. 2) in a network environment.

FIG. 2 is a block diagram illustrating an electronic device 201 in a network environment 200 according to various embodiments.

Referring to FIG. 2, the electronic device 201 in the network environment 200 may communicate with an electronic device 202 via a first network 298 (e.g., a short-range wireless communication network), or at least one of an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input module 250, a sound output module 255, a display module 260, an audio module 270, a sensor module 276, an interface 277, a connecting terminal 278, a haptic module 279, a camera module 280, a power management module 288, a battery 289, a communication module 290, a subscriber identification module (SIM) 296, or an antenna module 297. In some embodiments, at least one of the components (e.g., the connecting terminal 278) may be omitted from the electronic device 201, or one or more other components may be added in the electronic device 201. In some embodiments, some of the components (e.g., the sensor module 276, the camera module 280, or the antenna module 297) may be implemented as a single component (e.g., the display module 260).

The processor 220 may execute, for example, software (e.g., a program 240) to control at least one other component (e.g., a hardware or software component) of the electronic device 201 coupled with the processor 220, and may perform various data processing or computation. According to one embodiment, as at least part of the data processing or computation, the processor 220 may store a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), or an auxiliary processor 223 (e.g., a graphics processing unit (GPU), a neural processing unit (NPU), an image signal processor (ISP), a sensor hub processor, or a communication processor (CP)) that is operable independently from, or in conjunction with, the main processor 221. For example, when the electronic device 201 includes the main processor 221 and the auxiliary processor 223, the auxiliary processor 223 may be adapted to consume less power than the main processor 221, or to be specific to a specified function. The auxiliary processor 223 may be implemented as separate from, or as part of the main processor 221.

The auxiliary processor 223 may control at least some of functions or states related to at least one component (e.g., the display module 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223. According to an embodiment, the auxiliary processor 223 (e.g., the neural processing unit) may include a hardware structure specified for artificial intelligence model processing. An artificial intelligence model may be generated by machine learning. Such learning may be performed, e.g., by the electronic device 201 where the artificial intelligence is performed or via a separate server (e.g., the server 208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input module 250 may receive a command or data to be used by another component (e.g., the processor 220) of the electronic device 201, from the outside (e.g., a user) of the electronic device 201. The input module 250 may include, for example, a microphone, a mouse, a keyboard, a key (e.g., a button), or a digital pen (e.g., a stylus pen).

The sound output module 255 may output sound signals to the outside of the electronic device 201. The sound output module 255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 260 may visually provide information to the outside (e.g., a user) of the electronic device 201. The display module 260 may include, for example, a display, a hologram device, or a projector and control circuitry to control a corresponding one of the display, hologram device, and projector. According to an embodiment, the display module 260 may include a touch sensor adapted to detect a touch, or a pressure sensor adapted to measure the intensity of force incurred by the touch.

The audio module 270 may convert a sound into an electrical signal and vice versa. According to an embodiment, the audio module 270 may obtain the sound via the input module 250, or output the sound via the sound output module 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, a HDMI connector, a USB connector, a SD card connector, or an audio connector (e.g., a headphone connector).

The haptic module 279 may convert an electrical signal into a mechanical stimulus (e.g., a vibration or a movement) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to one embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the application processor (AP)) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device 204 via the first network 298 (e.g., a short-range communication network, such as Bluetooth™, wireless-fidelity (Wi-Fi) direct, or infrared data association (IrDA)) or the second network 299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 292 may identify and authenticate the electronic device 201 in a communication network, such as the first network 298 or the second network 299, using subscriber information (e.g., international mobile subscriber identity (IMSI)) stored in the subscriber identification module 296.

The wireless communication module 292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 292 may support a high-frequency band (e.g., the mmWave band) to achieve, e.g., a high data transmission rate. The wireless communication module 292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 292 may support various requirements specified in the electronic device 201, an external electronic device (e.g., the electronic device 204), or a network system (e.g., the second network 299). According to an embodiment, the wireless communication module 292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 297 may transmit or receive a signal or power to or from the outside (e.g., the external electronic device) of the electronic device 201. According to an embodiment, the antenna module 297 may include an antenna including a radiating element composed of a conductive material or a conductive pattern formed in or on a substrate (e.g., a printed circuit board (PCB)). According to an embodiment, the antenna module 297 may include a plurality of antennas (e.g., array antennas). In such a case, at least one antenna appropriate for a communication scheme used in the communication network, such as the first network 298 or the second network 299, may be selected, for example, by the communication module 290 (e.g., the wireless communication module 292) from the plurality of antennas. The signal or the power may then be transmitted or received between the communication module 290 and the external electronic device via the selected at least one antenna. According to an embodiment, another component (e.g., a radio frequency integrated circuit (RFIC)) other than the radiating element may be additionally formed as part of the antenna module 297.

According to various embodiments, the antenna module 297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the electronic devices 202 or 204 may be a device of a same type as, or a different type, from the electronic device 201. According to an embodiment, all or some of operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, mobile edge computing (MEC), or client-server computing technology may be used, for example. The electronic device 201 may provide ultra low-latency services using, e.g., distributed computing or mobile edge computing. In another embodiment, the external electronic device 204 may include an internet-of-things (IoT) device. The server 208 may be an intelligent server using machine learning and/or a neural network. According to an embodiment, the external electronic device 204 or the server 208 may be included in the second network 299. The electronic device 201 may be applied to intelligent services (e.g., smart home, smart city, smart car, or healthcare) based on 5G communication technology or IoT-related technology.

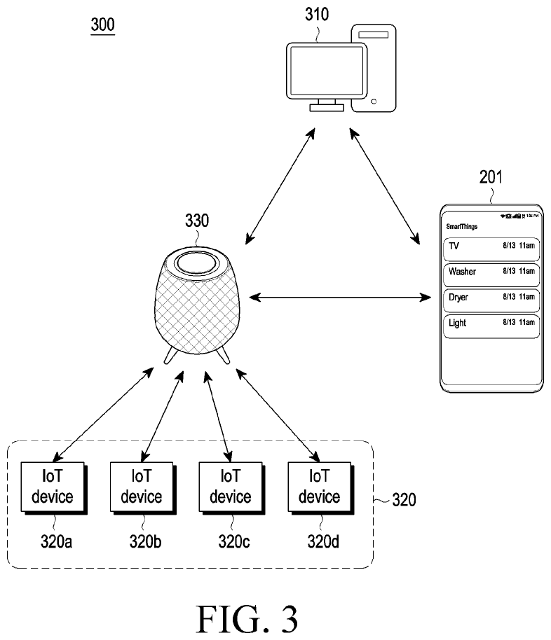

FIG. 3 illustrates a network providing an IoT service according to an embodiment.

In FIG. 3, the network 300 may include a server 310 that operates as an IoT cloud, an electronic device 201 that communicates with the server 310 through network communication (e.g., the Internet), and at least one IoT device 320 (e.g., IoT devices 320a, 320b, 320c, and 320d) that supports IoT technology. In an embodiment, the at least one IoT device 320 may include at least one small things device (e.g., a sensor device), for example, operating with a battery. In an embodiment, the at least one IoT device 320 may use a low-power communication protocol, such as ZigBee, Z-Wave, and/or Bluetooth Low Energy (BLE), to connect to the Internet instead of using Wi-Fi or Ethernet requiring high power consumption.

In an embodiment, the at least one IoT device 320 may be configured to directly access the network communication (e.g., the Internet) through the low-power communications protocol (e.g., ZigBee, Z-Wave, and/or BLE), or may be connected to the network communication (e.g., the Internet or the server 310) through an external electronic device (e.g., a hub device 330) that relays the low-power communication protocol and the network communication. The hub device 330 may support a connection between the at least one IoT device 320 and the electronic device 201 and/or a connection between the at least one IoT device 320 and the server 310. In an embodiment, the electronic device 201 may communicate with the at least one IoT device 320 through the hub device 330, through the server 310, through long-range wireless communication (e.g., a second network 299), or short-range wireless communication (e.g., a first network 298).

In an embodiment, the at least one IoT device 320 may be controlled (e.g., report a state and/or execute a designated operation) by a remote command (e.g., a control command of the electronic device 201), and may include, for example, at least one of a door lock, a presence sensor, a television, an air conditioner, a refrigerator, a washing machine, a lighting device, a security camera, one or more sensors, or a window treatment.

In an embodiment, the at least one IoT device 320 may communicate with the electronic device 201 and/or the server 310 through the hub device 330. In an embodiment, the at least one IoT device 320 may be configured to communicate with the hub device 330 and/or the electronic device 201 through the long-range wireless communication (e.g., the second network 299) or the short-range wireless communication (e.g., the first network 298). In an embodiment, when the at least one IoT device 320 is a small things device, the at least one IoT device 320 may be connected to the hub device 330 through the low-power communication protocol, and may be configured to communicate with the server 310 and/or the electronic device 201 through the hub device 330.

In an embodiment, the electronic device 201 may be a personal electronic device, such as a smartphone, a tablet PC, or a wearable device, or an electronic device that includes a display and a user interface, such as a television or a control console. The electronic device 201 may discover the hub device 330, and may perform an onboarding procedure (e.g., a hub onboarding procedure) of authenticating the discovered hub device 330 and registering the same with the server 310. The hub device 330 registered with the server 310 may perform an onboarding procedure (e.g., a device onboarding procedure) of authenticating the at least one IoT device 320 and registering the authenticated device 320 with the server 310 to be associated with a user account. The electronic device 201 may monitor, configure, and control the at least one IoT device 320 registered with the server 310 by using the user account.

In an embodiment, the electronic device 201 may monitor a state of the at least one IoT device 320 that the user uses for an IoT service, or may control the at least one IoT device 320 (e.g., transmit a control command to instruct the at least one IoT device 320 to execute a designated operation). In an embodiment, the electronic device 201 may be an owner device registered with the server 310. In an embodiment, at least one member device that includes at least some functions and/or rights of the electronic device 201 may be included in the network 300. In an embodiment, the member device (not shown) may not execute an onboarding procedure for the hub device 330 and/or the at least one IoT device 320, but may execute a function of identifying or controlling a state of the at least one IoT device 320 registered with the server 310.

In an embodiment, the hub device 330 may operate the IoT service, and may be a server or gateway disposed inside a building (e.g., a house, or a hotel) or a remote server disposed outside the building. In an embodiment, the hub device 330 may be a home appliance with a hub function, such as a smartphone, a tablet PC, a personal computer (PC), a TV, or an artificial intelligence (AI) speaker. The hub device 330 may collect state information and/or sound information from the at least one IoT device 320 or directly record sound information (e.g., by using a built-in or connected microphone 410), and may report the sound information to the server 310 according to at least one of the following embodiments. The hub device 330 may determine an abnormal situation (e.g., an abnormal event) of the network 300, based on the state information and the sound information, according to at least one of the following embodiments.

In an embodiment, at least some (e.g., a first IoT device 320a) of the at least one IoT device 320 may include a sensor, and the first IoT device 320a may report collected state information (e.g., sensor data) to the server 310 through the hub device 330 according to a designated triggering condition (e.g., periodically or based on an event). In an embodiment, at least some (e.g., a second IoT device 320b) of the at least one IoT device 320 may be a device that includes a sound recording function, and the second IoT device 320b may record an ambient sound signal, and may report sound information related to the recorded sound signal (e.g., the amplitude of the sound signal) to the hub device 330 or to the server 310 through the hub device 330 according to a designated triggering condition (e.g., periodically or based on an event). In an embodiment, the second IoT device 320b may be configured to record a sound signal having an amplitude exceeding a designated threshold value.

In an embodiment, the at least one IoT device 320 may perform a corresponding operation (e.g., a designated function) according to a control command transmitted by the electronic device 201 through the hub device 330 or through the server 310 and the hub device 330. In an embodiment, the at least one IoT device 320 may receive a control command generated by the server 310 according to a designated automation rule through the hub device 330, and may perform an operation corresponding to the control command.

In an embodiment, the hub device 330 may be connected to the at least one IoT device 320 by using the low-power communication protocol (e.g., ZigBee, Z-Wave, and/or BLE), and may transmit information (e.g., state information) received from the at least one IoT device 320 to the server 310. In an embodiment, the hub device 330 may interpret information (e.g., state information or a request) received from the at least one IoT device 320, and may operate according to an interpretation result.

In an embodiment, the electronic device 201 may include (e.g., store and/or execute) an application (e.g., an IoT application) for communicating with the hub device 330 and/or the at least one IoT device 320, and may display information (e.g., state information) collected by the at least one IoT device 320 by executing the IoT application on a display module (e.g., a display module 260). In an embodiment, the electronic device 201 may transmit a control command (e.g., a control command to instruct the at least one IoT device 320 to execute a designated operation) input from the user through the IoT application to the at least one IoT device 320 through the server 310 and/or the hub device 330.

In an embodiment, the electronic device 201 may install an IoT application to enable the user to identify and configure the at least one IoT device 320, and may perform a hub onboarding procedure of registering the hub device 330 with the server 310 through the IoT application. After the hub device 330 is registered, the electronic device 201 may receive an onboarding result of the at least one IoT device 320 registered with the server 310 through a device onboarding procedure from the server 310, and may identify, configure, and control the at least one IoT device 320 through the IoT application.

In an embodiment, the server 310 may store state information about the at least one IoT device 320 connected through the hub device 330, and may provide the state information to the electronic device 201. In an embodiment, the server 310 may transmit a control command received from the electronic device 201 to the at least one IoT device 320 through the hub device 330. In an embodiment, the server 310 may store at least one automation rule for the at least one IoT device 320, and may generate a control command according to the at least one automation rule to transmit the control command to the at least one IoT device 320 through the hub device 330.

In an embodiment, the server 310 may receive state information and/or sound information related to the network 300 from at least one of 1) the at least one IoT device 320, 2) the hub device 330, or 3) the electronic device 201. The server 310 may determine an abnormal situation (e.g., an abnormal event) of the network 300, based on the state information and the sound information, according to at least one of the following embodiments.

In an embodiment, the network 300 (providing the IoT service) may include a function of monitoring an abnormal situation, such as an attack on the at least one IoT device 320 and/or a malfunction of the at least one IoT device 320. In an embodiment, the attack may include at least one of (a) a fake event attack in which an attacker generates an event that does not actually occur (e.g., a fake event) and injects the event into the network to induce occurrence of another associated event, (b) a fake command attack in which an attacker transmits a malicious command to the IoT device to arbitrarily control the IoT device, (c) an event interception attack in which an attacker intercepts an event and blocks the event from being transmitted to the server 310, (d) a command interception attack in which an attacker blocks a command to be transmitted to the IoT device, or a compromised device attack.

In an embodiment, the malfunction may include at least one of a faulty event due to a sensor malfunction, a ghost command to execute a wrong operation due to a device malfunction, event loss (or large delay) in which an event reported from the IoT device to the server 310 is not transmitted or is delayed, or command failure in which a command transmitted from the server 310 is not transmitted to the IoT device.

In the following embodiments, the network 300 (e.g., the hub device 330 or the server 310) may monitor an abnormal situation, based on the state information (e.g., event information and/or sensor data) about the at least one IoT device 320 and sound information collected by a device (e.g., the hub device 330 or the at least one IoT device 320) including a microphone (e.g., the microphone 410). In an embodiment, the hub device 330 may be configured to report the state information and/or the sound information to the server 310. In an embodiment, the server 310 may be configured to monitor an abnormal situation, based on the state information and/or the sound information. In an embodiment, the hub device 330 may be configured to monitor an abnormal situation by directly using the state information and/or the sound information instead of reporting the same to the server 310.

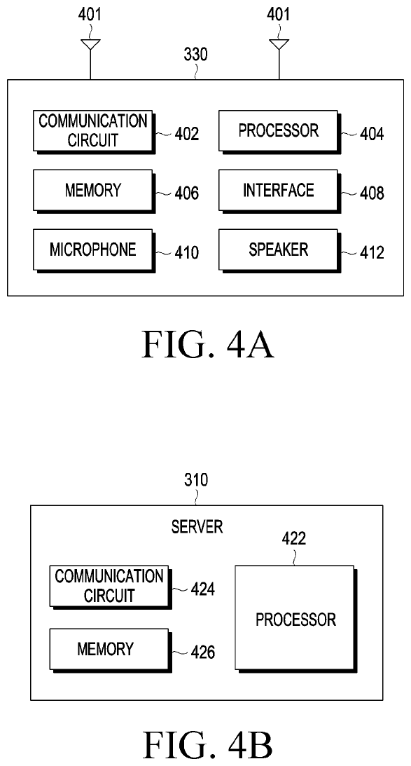

FIG. 4A is a block diagram illustrating a configuration of a hub device 330 according to an embodiment.

Referring to FIG. 4A, the hub device 330 may be configured to connect at least one external electronic device (e.g., at least one IoT device 320) to a server 310 through a network communication channel (e.g., the Internet) to implement an IoT service (e.g., an event-based IoT service) in a wireless communication network (e.g., an IoT network). For example, the IoT network may be a smart home network, and the IoT service may be an automation service. The hub device 330 may include at least one of a communication circuit 402, a processor 404, memory 406, an interface 408, a microphone 410, or a speaker 412. In an embodiment, the hub device 330 may further include a display.

In an embodiment, at least one of the communication circuit 402, the processor 404, the memory 406, or the interface 408 may be configured to be similar to or substantially the same as the communication module 290, the processor 220, the memory 230, or the interface 277 described in FIG. 2, respectively.

In an embodiment, the communication circuit 402 of the hub device 330 may support at least one of ZigBee, Z-Wave, Wi-Fi, Bluetooth Classic, and/or Bluetooth Low Energy (BLE). The communication circuit 402 may be configured to transmit or receive a signal to or from the at least one IoT device 320, the server 310, or the electronic device 201 by using one or two or more antennas 401.

In an embodiment, the communication circuit 402 may receive a signal including state information from the at least one IoT device 320, and the processor 404 may obtain the state information from the signal. In an embodiment, the state information may include event information and/or sensor data detected by the at least one IoT device 320. The processor 404 may report the state information to the server 310 through the communication circuit 402.

According to an embodiment, the communication circuit 402 may include one communication circuit or a plurality of communication circuits (e.g., the communication module 290 of FIG. 2), and the one communication circuit or the plurality of communication circuits may include communication circuits based on Zigbee, Z-Wave, Wi-Fi, Bluetooth Classic, and/or BLE. According to an embodiment, the hub device 330 may include separate communication circuits respectively based on ZigBee, Z-Wave, Wi-Fi, Bluetooth Classic, and/or BLE, or may include at least one communication circuit based on at least one of ZigBee, Z-Wave, Wi-Fi, Bluetooth Classic, and/or BLE or a combination thereof.

The hub device 330 may include the interface 408 (e.g., the interface 277 of FIG. 2) that provides a wired and/or wireless interface for communicating with external components. In an embodiment, at least some of the one or more antennas 401, the communication circuit 402, or the interface 408 may be configured as at least part of the communication module 290 and the antenna module 297 of FIG. 2.

The hub device 330 may include the processor 404 (e.g., the processor 220 of FIG. 2) that may be configured with one or two or more single core processors or one or two or more multi-core processors, and the memory 406 (e.g., the memory 230 of FIG. 2) that stores instructions for an operation of the hub device 330 and management data (e.g., learning-based modeling data).

The hub device 330 may include the microphone 410 and/or the speaker 412, and may collect an ambient sound signal by using the microphone 410. In an embodiment, the hub device 330 may collect a sound signal in real time, or may collect a sound signal during a designated time, based on detection of an event by the at least one IoT device 320. The processor 404 may report sound information related to the sound signal to the server 310 through the communication circuit 402. In an embodiment, the sound information may include the amplitude (e.g., decibel (dB)) of the sound signal. In an embodiment, the processor 404 may report the sound information to the server 310, based on determining an out-of-home situation in which there is no person in a designated area (e.g., a house) corresponding to the network 300, based on the state information received through the communication circuit 402.

In an embodiment, the processor 404 may determine whether an abnormal situation (e.g., an abnormal event) occurs in the network 300, based on the state information and/or the sound information.

FIG. 4B is a block diagram illustrating a configuration of a server 310 according to an embodiment.

Referring to FIG. 4B, the server 310 may be connected to at least one external electronic device (e.g., at least one IoT device 320) through network communication (e.g., the Internet) to implement an IoT service (e.g., an event-based IoT service) in a wireless communication network (e.g., an IoT network). For example, the IoT network may be a smart home network, and the IoT service may be an automation service. The server 310 may include at least one of a communication circuit 424, a processor 422, or memory 426.

In an embodiment, at least one of the processor 422, the communication circuit 424, or the memory 426 may be configured to be similar to or substantially the same as at least one of the processor 220, the communication module 290, or the memory 230 described in FIG. 2, respectively.

In an embodiment, the communication circuit 424 of the server 310 may include at least one communication module that supports network communication (e.g., the Internet). In an embodiment, the communication circuit 424 may receive a signal including state information and/or sound information from the at least one IoT device 320 directly or through a hub device 330, and the processor 422 may obtain the state information and/or the sound information from the signal. In an embodiment, the state information may include event information and/or sensor data detected by the at least one IoT device 320.

The server 310 may include the processor 422 (e.g., the processor 220 of FIG. 2) that may be configured with one or two or more single core processors or one or two or more multi-core processors, and the memory 426 (e.g., the memory 230 of FIG. 2) that stores instructions for an operation of the server 310 and management data (e.g., learning-based modeling data).

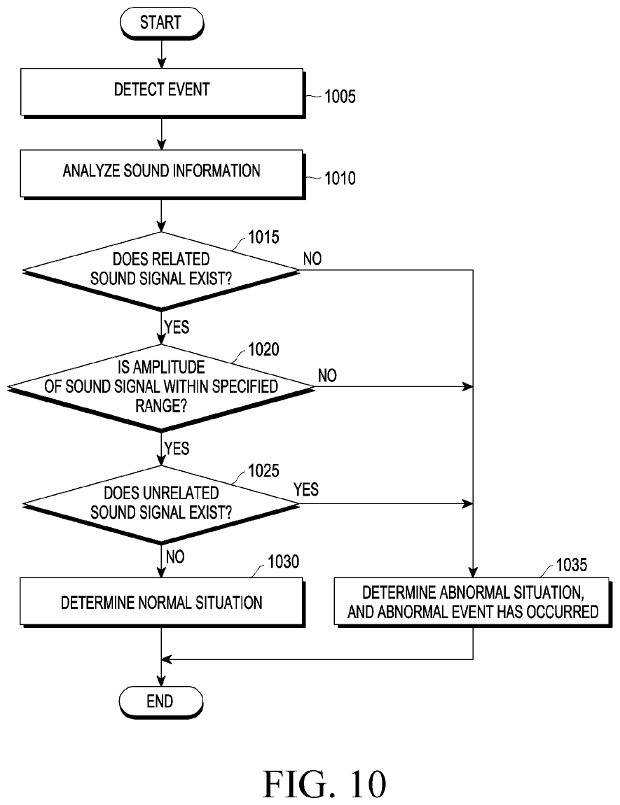

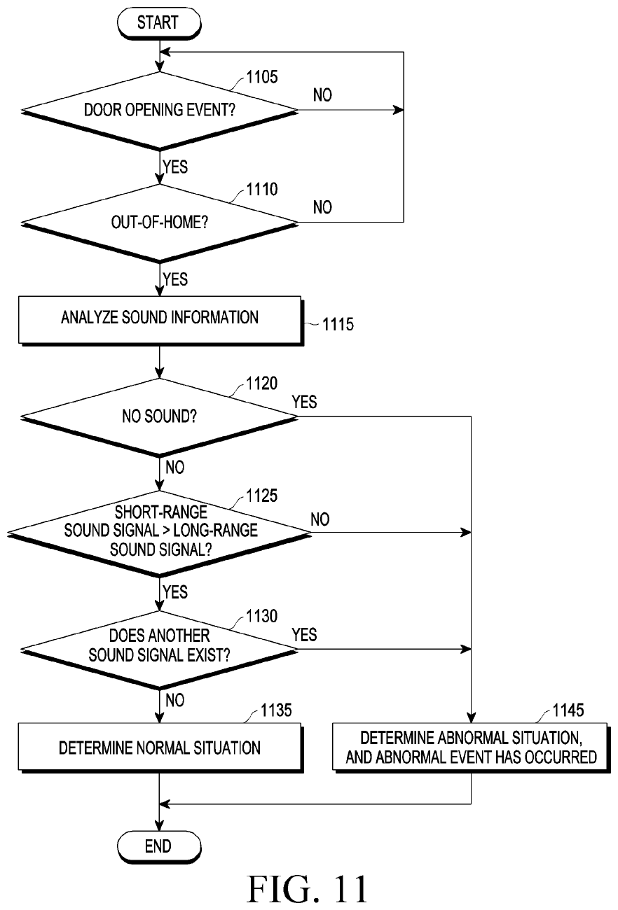

In an embodiment, the processor 422 may determine whether an abnormal situation (e.g., an abnormal event) occurs in the network 300, based on the state information and/or the sound information collected from the at least one IoT device 320 and/or the hub device 330. An illustrative operation of monitoring an abnormal situation, based on state information and/or sound information will be described with reference to FIG. 10 and FIG. 11.

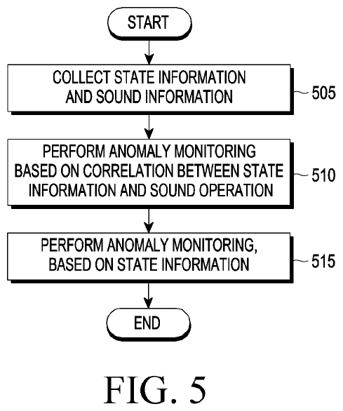

FIG. 5 is a flowchart illustrating a procedure of performing sound-based anomaly monitoring according to an embodiment. In an embodiment, at least one of the following operations may be performed by the processor 422 of the server 310. Depending on embodiments, at least one of the following operations may be omitted, modified, or performed in a different order.

In FIG. 5, in operation 505, the server 310 (e.g., the processor 422) may receive state information and/or sound information collected by at least one IoT device 320 and/or a hub device 330. In an embodiment, the state information may be related to sensor data about the at least one IoT device 320 (e.g., the first IoT device 702 including a sensor). In an embodiment, the sound information may be related to one or more sound signals collected by the at least one IoT device 320 (e.g., the first IoT device 702, the second IoT device 704, the third IoT device 706, which includes a microphone) and/or the hub device 330. In an embodiment, the server 310 (e.g., the processor 422) may receive state information and/or sound information about the at least one IoT device 320 directly from the at least one IoT device 320 or through the hub device 330.

In operation 510, the server 310 (e.g., the processor 422) may perform sound-based anomaly monitoring (e.g., first anomaly monitoring) of determining whether an abnormal situation (e.g., an abnormal event) is detected by comparing the state information with the sound information (e.g., based on a correlation between the state information and the sound information). In an embodiment, the server 310 (e.g., the processor 422) may perform the first anomaly monitoring, based on learning-based modeling. In an embodiment, the server 310 (e.g., the processor 422) may perform the first anomaly monitoring by analyzing a correlation between the state information and the sound information, based on a criterion (e.g., management data) generated through the learning-based modeling, thereby determining whether there is an abnormal situation. An abnormal situation (e.g., an abnormal event) detected as a result of the first anomaly monitoring may be stored in the memory 426 of the server 310, notified to an electronic device 201, or reported to a related system operator (e.g., a security system operator).

In operation 515, the server 310 (e.g., the processor 422) may perform second anomaly monitoring of determining whether an abnormal situation (e.g., an abnormal event) occurs by analyzing the state information. In an embodiment, when no abnormal situation is detected as a result of the first anomaly monitoring (e.g., physical anomaly detection) based on the correlation between the state information and the sound information in the operation 510, the server 310 (e.g., the processor 422) may perform the second anomaly monitoring (e.g., logical anomaly detection) based on content of the state information in operation 515. In an embodiment, the second anomaly monitoring of operation 515 may be performed to supplement the first anomaly monitoring of operation 510.

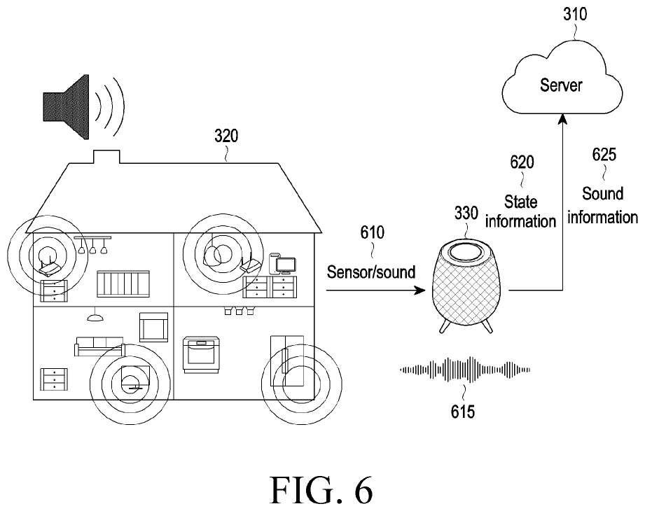

FIG. 6 illustrates operations for collecting the state information and the sound information according to an embodiment.

Referring to FIG. 6, a hub device 330 may receive a report 610 including at least one piece of sensor data and/or at least one sound signal from at least one IoT device 320. The hub device 330 may collect a sound signal 615 through the microphone 410. In an embodiment, the hub device 330 may receive a report on an amplitude (or a strength) of the sound signal from the at least one IoT device 320. The hub device 330 may report the state information 620 and/or the sound information 625 generated based on the collected information (e.g., the report 610 and/or e amplitude of the sound signal 615) to a server 310. In an embodiment, the hub device 330 may transmit the state information 620 and/or the sound information 625 to the server 310, based on a designated triggering condition (e.g., periodically or based on an event).

In an embodiment, the state information 620 may include event information and/or sensor data detected by the at least one IoT device 320 (e.g., the first IoT device 702 including a sensor). In an embodiment, the state information 620 may include at least one event indicating at least one of a bulb on/off, a robot vacuum cleaner on/off, a door lock on/off, or a window on/off. In an embodiment, the sound information 625 may include a sound signal collected by the at least one IoT device 320 (e.g., the first IoT device 702, the second IoT device 704, the third IoT device 706, which includes a microphone) and/or amplitudes of sound signals collected by the hub device 330. The sound signals may include at least one of a sound of a vacuum cleaner operating, a sound of a door opening, a sound of a switch turning on or off, or a sound of a window opening or closing.

In an embodiment, the hub device 330 may report the sound information 625 to perform anomaly monitoring (e.g., logical anomaly detection), for example, in a situation in which physical anomaly detection is impossible (e.g., an out-of-home situation). In an embodiment, the hub device 330 may be configured not to report the sound information 625 to the server 310 considering invasion of privacy when at least one person (e.g., at least one registered user) is in a designated area (e.g., a home) corresponding to a network 300. In an embodiment, the hub device 330 may report the sound information 625 to the server 310 only when the out-of-home situation is detected by using a presence sensor, which corresponds to the at least one IoT device 320, and/or by using a current location of the electronic device 201. In an embodiment, the out-of-home situation may mean that there is no person at home. In an embodiment, the out-of-home situation may mean that there is no registered user at home.

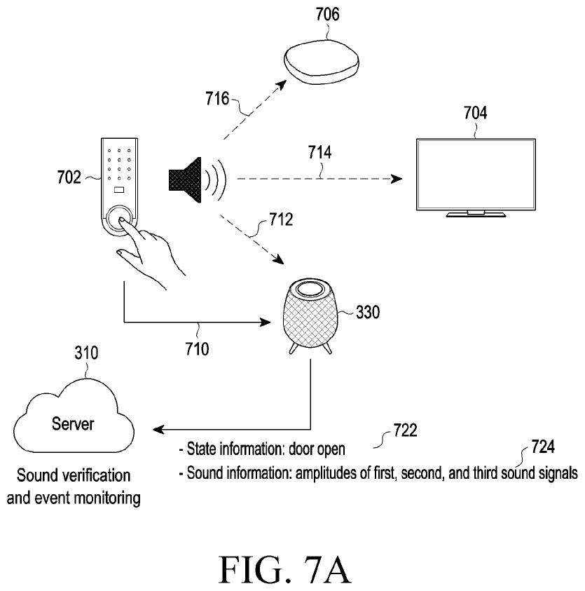

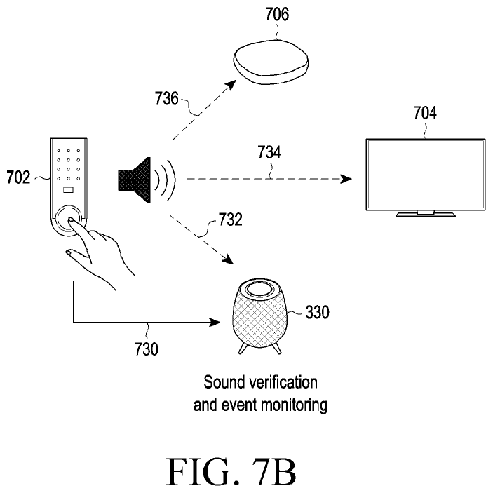

FIG. 7A illustrates sound-based anomaly monitoring according to an embodiment.

In FIG. 7A, the hub device 330 may receive sensor data 710 (e.g., door open) from the first IoT device 702 (e.g., a door lock). The hub device 330 may record a first sound signal 712 generated due to an operation of the first IoT device 702 (e.g., the door lock). In an embodiment, the second IoT device 704 and the third IoT device 706 located adjacent to the first IoT device 702 (e.g., the door lock) may record second signal 714 and third sound signal 716 (e.g., a door unlocking sound and/or a door opening sound) generated due to an operation of the first IoT device 702 (e.g., door unlocking).

The hub device 330 may report state information 722 (e.g., door open) based on the sensor data 710 and sound information 724 based on the first sound signal 712, the second sound signal 714, and the third sound signal 716 to the server 310. In an embodiment, the sound information 724 may be collected substantially simultaneously with the state information 722 or at least within a designated time range. In an embodiment, the sound information 724 may include a device identification (ID) of the hub device 330, the amplitude of the first sound signal 712, a device ID of the IoT device 704, the amplitude of the second sound signal 714, a device ID of the IoT device 706, and the amplitude of the third sound signal 716. The server 310 may receive the state information 722 and the sound information 724, and may perform anomaly monitoring (e.g., first anomaly monitoring) by comparing the state information 722 and the sound information 724.

The server 310 may identify an event (e.g., a door opening event) detected in a network 300, based on the state information 722, and may analyze the sound information 724, based on management data (e.g., management data in Table 1) related to the event. In an embodiment, when the sound information 724 does not satisfy a condition based on the management data, the server 310 may determine that an abnormal situation is detected. In an embodiment, the management data may be generated by learning-based modeling performed for a designated period (e.g., two to four weeks after the hub device 330 is installed).

FIG. 7B illustrates sound-based anomaly monitoring according to an embodiment.

In FIG. 7B, a hub device 330 may receive sensor data 730 (e.g., door open) from the first IoT device 702 (e.g., a door lock). The hub device 330 may record a first sound signal 732 generated due to an operation of the first IoT device 702 (e.g., the door lock). In an embodiment, the second IoT device 704 and the third IoT device 706 located adjacent to the first IoT device 702 (e.g., the door lock) may record a second sound signal 734 and a third sound signal 736 (e.g., a door unlocking sound and/or a door opening sound) generated due to an operation of the first IoT device 702 (e.g., door unlocking).

The hub device 330 may perform anomaly monitoring (e.g., first anomaly monitoring), based on state information 722 (e.g., door open) based on the sensor data 730 and the first sound signal 732, the second signal 734, and the third signal 736. In an embodiment, the hub device 330 may identify an event (e.g., a door opening event) detected in the network 300, based on the state information 722, and may analyze the first sound signal 732, the second signal 734, and the third sound signal 736, based on management data (e.g., management data in Table 1) related to the event. In an embodiment, when the first sound signal 732, the second signal 734, and the third sound signal 736 do not satisfy a condition based on the management data, the hub device 330 may determine that an abnormal situation is detected.

In an embodiment, the management data may show a correlation between state information and sound information, and may be generated by a learning-based modeling (e.g., on a AI model stored in any of the electronic devices such as the server 310 or the hub device 330) performed for a designated period (e.g., two to four weeks after the hub device 330 is installed). In an embodiment, the management data may be generated by the hub device 330, or may be generated by the server 310 and provided to the hub device 330. In an embodiment, the management data may be used by the hub device 330, or may be used by the server 310.

In an embodiment, the server 310 (e.g., a processor 422) may perform the learning-based modeling, based on state information and/or sound information collected from at least one IoT device 320 and/or the hub device 330. In an embodiment, the learning-based modeling may include analyzing an event indicated by the state information and the amplitude of sound signals recorded in at least one IoT device 320 and/or the hub device 330 corresponding to the event. In an embodiment, the learning-based modeling may include generating management data (e.g., management data in Table 1) necessary to detect an abnormal situation, based on the state information and/or the sound information. The management data may show a correlation between an event and a sound, and may be used as a criterion for determining whether an abnormal situation is detected (e.g., the first anomaly monitoring in operation 510).

In an embodiment, the management data may include a list of related devices corresponding to the event and/or a sound level corresponding to each related device. In an embodiment, the server 310 (e.g., the processor 422) may generate the management data by performing learning-based modeling, based on state information and/or sound information collected during a designated period. In an embodiment, the designated period may include a designated time interval (e.g., two to four weeks) after the network 300 is activated (e.g., after the sound-based first anomaly monitoring is initiated).

In an embodiment, the designated period may be considered as a training period for the learning-based modeling, and the server 310 (e.g., the processor 422) may not perform anomaly monitoring (e.g., the first anomaly monitoring in operation 510) during the designated period. In an embodiment, the server 310 (e.g., the processor 422) may update the management data by performing the learning-based modeling, based on the state information and/or the sound information collected by the at least one IoT device 320 and/or the hub device 330 even after the designated period.

In an embodiment, the management data may include at least one of an event identifier, a sound source, the list of related devices, or a sound level for each device. In an embodiment, regarding the door opening event, the sound source may include the door lock, the list of related devices may include at least one IoT device (e.g., a related IoT device) (e.g., an AI speaker (e.g., the hub device 330), a TV (e.g., the IoT device 704), and a wireless charger (e.g., the IoT device 706)) capable of hearing a sound signal with an amplitude greater than a designated threshold value when the door opening event occurs, and the sound level may include an amplitude range of a sound signal detected for each related IoT device.

In an embodiment, the management data may be configured as shown in Table 1.

TABLE 1

| Event ID | Sound source | Related device | Sound level |
|---|---|---|---|
| Door open | Door lock | AI speaker | 50-55 dB |
| | | TV | 40-45 dB |
| | | Wireless charger | 30-35 dB |
| Window open | Window sensor | Wireless charger | 60-65 dB |
| | | TV | 45-50 dB |

The following embodiments show that the server 310 monitors an abnormal situation, but those skilled in the art will understand that the hub device 330 may perform the same operation without a further explanation.

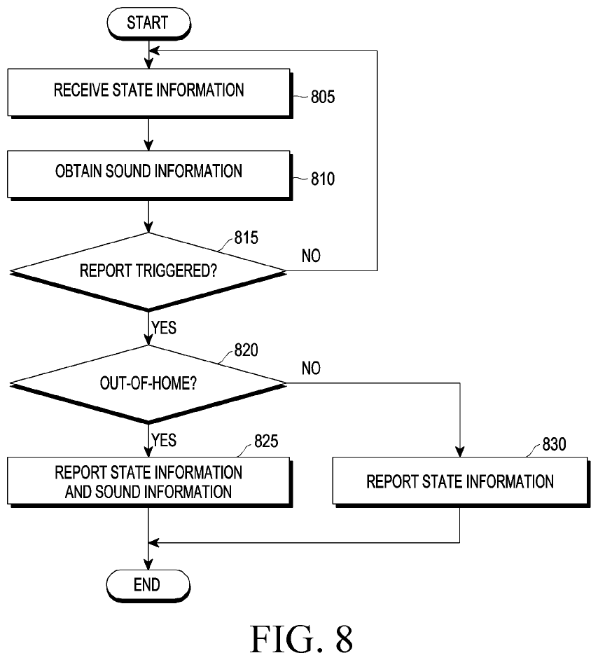

FIG. 8 is a flowchart illustrating a reporting procedure of a hub device 330 according to an embodiment. According to an embodiment, at least one of the following operations may be performed by a processor 404 of the hub device 330. Depending on embodiments, at least one of the following operations may be omitted, modified, or performed in a different order.

Referring to FIG. 8, in operation 805, the hub device 330 (e.g., the processor 404) may receive state information (e.g., sensor data) (e.g., state information 620) from at least one IoT device 320 (e.g., one or more sensor devices shown in FIG. 1). In an embodiment, the at least one IoT device 320 may transmit the state information to the hub device 330 periodically, according to a designated triggering condition, or in response to a request from the hub device 330. In an embodiment, the state information may include at least one of a bulb on/off, a robot vacuum cleaner on/off, a door lock on/off, or a window on/off.

In operation 810, the hub device 330 (e.g., the processor 404) may obtain sound information (e.g., sound information 625) related to a network (e.g., a network 300). In an embodiment, the hub device 330 (e.g., the processor 404) may receive a sound signal by using the microphone 410, and may directly generate sound information related with the sound signal. In an embodiment, the hub device 330 (e.g., the processor 404) may receive sound information from at least one IoT device (e.g., the IoT device 704 or 706). In an embodiment, the sound information may include at least one IoT device identifier and at least one sound signal amplitude.

In operation 815, the hub device 330 (e.g., the processor 404) may determine whether a designated report triggering condition is satisfied. In an embodiment, the report triggering condition may include at least one of a period, a designated triggering event, or a request from a server 310. When the report triggering condition is satisfied, the hub device 330 (e.g., the processor 404) may perform operation 820. When the report triggering condition is not satisfied, the hub device 330 (e.g., the processor 404) may return to operation 805.

In operation 820, the hub device 330 (e.g., the processor 404) may detect in-home or out-of-home indicating whether at least one person (e.g., a registered user) exists within an area (e.g., home) corresponding to the network 300. In an embodiment, the hub device 330 (e.g., the processor 404) may determine the in-home or out-of-home, based on the state information received in operation 805. The hub device 330 (e.g., the processor 404) may determine the in-home or out-of-home, based on sensor data from a presence sensor, which may be one of the at least one IoT device 320. In an embodiment, the hub device 330 (e.g., the processor 404) may determine the in-home or out-of-home, based on whether at least one registered (e.g., onboarded) user device (e.g., the electronic device 201) exists within the network 300. When a person (e.g., the registered user) does not exist (is out-of-home) in the network 300, the hub device 330 (e.g., the processor 404) may perform operation 825. When the person exists within the network 300, the hub device 330 (e.g., the processor 404) may perform operation 830.

In operation 825, the hub device 330 (e.g., the processor 404) may report the state information and/or the sound information to the server 310.

In operation 830, the hub device 330 (e.g., the processor 404) may report only the state information to the server 3100 without the sound information.

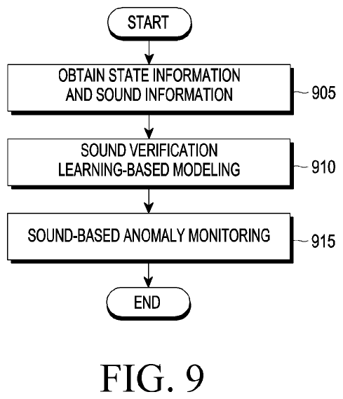

FIG. 9 is a flowchart illustrating an anomaly monitoring procedure of the server 310 according to an embodiment. According to an embodiment, at least one of the following operations may be performed by a processor 422 of the server 310. Depending on embodiments, at least one of the following operations may be omitted, modified, or performed in a different order.

In FIG. 9, in operation 905, the server 310 (e.g., the processor 422) may obtain (e.g., receive) state information and/or sound information from at least one IoT device 320 and/or the hub device 330. In operation 910, the server 310 (e.g., the processor 422) may perform learning-based modeling, based on the state information and/or the sound information within a designated period. In an embodiment, the learning-based modeling may include generating management data for sound verification (e.g., the management data in Table 1). The state information and/or the sound information received for the designated period may not be used for anomaly detection. In an embodiment, the state information and the sound information may be measured simultaneously (e.g., within a designated time interval).

In operation 915, the server 310 (e.g., the processor 422) may perform sound-based anomaly monitoring of determining whether an abnormal situation (e.g., an abnormal event) is detected, based on the state information and/or the sound information after a lapse of the designated period. In an embodiment, the server 310 (e.g., the processor 422) may determine whether a correlation between the state information and the sound information is appropriate, based on the management data. An example of sound-based anomaly monitoring will be described with reference to FIG. 10 and FIG. 11.

FIG. 10 is a flowchart illustrating a sound-based anomaly monitoring procedure according to an embodiment. According to an embodiment, at least one of the following operations may be performed by a processor 422 of a server 310. Depending on embodiments, at least one of the following operations may be omitted, modified, or performed in a different order.

In FIG. 10, in operation 1005, the server 310 (e.g., the processor 422) may identify an event (e.g., a first event), based on state information (e.g., the state information received in operation 905). For example, the server 310 (e.g., the processor 422) may identify that the state information includes a door opening event detected by a door lock. In operation 1010, the server 310 (e.g., the processor 422) may analyze sound information (e.g., the sound information received in operation 905). In an embodiment, the server 310 (e.g., the processor 422) may identify the amplitude of a sound signal for each device (e.g., 50 dB for a hub device 330 and 40 dB for an IoT device 704) included in the sound information.

In operation 1015, the server 310 (e.g., the processor 422) may determine whether at least one sound signal related to the first event exists, based on the sound information. In an embodiment, the server 310 (e.g., the processor 422) may identify a related device list (e.g., an AI speaker, a TV, and a wireless charger) of the first event (e.g., the door opening event) from management data (e.g., the management data in Table 1) generated through the learning-based modeling, and may determine whether the sound information includes amplitudes of sound signals recorded by devices (e.g., the AI speaker, the TV, and the wireless charger) in the related device list.

In an embodiment, when the sound information includes the amplitude of a sound signal measured by at least one device in the related device list, the server 310 (e.g., the processor 422) may determine that there is a sound signal related to the first event, and may perform operation 1020. When the sound information does not include the amplitude of the sound signal measured by the at least one device in the related device list, the server 310 (e.g., the processor 422) may determine that there is no sound signal related to the first event, and may perform operation 1035.

In operation 1020, the server 310 (e.g., the processor 422) may determine whether the amplitude of at least one sound signal related to the first event is within a designated range. In an embodiment, the designated range may be defined by the management data. When the amplitude of the at least one sound signal is within the designated range, the server 310 (e.g., the processor 422) may perform operation 1025. When the amplitude of the at least one sound signal is out of the designated range, the server 310 (e.g., the processor 422) may perform operation 1035.

In operation 1025, the server 310 (e.g., the processor 422) may determine whether there is at least one sound signal that is not related to the first event. In an embodiment, the server 310 (e.g., the processor 422) may determine whether the amplitude of a sound signal recorded by another IoT device (that is not included in the related device list corresponding to the first event) is included in the sound information. When there is at least one sound signal that is not related to the first event, the server 310 (e.g., the processor 422) may perform operation 1035. When at least one sound signal not related to the first event does not exist, the server 310 (e.g., the processor 422) may perform operation 1030.

In operation 1030, the server 310 (e.g., the processor 422) may determine that an abnormal situation has not occurred in an area (e.g., home) corresponding to a network 300, for example, may determine a normal situation, and may terminate the procedure.

In operation 1035, the server 310 (e.g., the processor 422) may determine that an abnormal situation has occurred in the area (e.g., home) corresponding to the network 300. The abnormal situation (e.g., an abnormal event) detected as a result of anomaly monitoring may be stored in the memory 426 of the server 310, notified to a user (e.g., an electronic device 201 and/or a computer device connected to a user account), or reported to a related system operator (e.g., a security system operator).

In an embodiment, the server 310 (e.g., the processor 422) may determine whether sound signals corresponding to the first event reported to the server 310 have occurred through the state information. For example, in occurrence of the door opening event, when the amplitude of a first sound signal recorded by the AI speaker (e.g., the hub device 330 located in a living room) closest to an entrance is the largest and the amplitude of a second sound signal recorded by the TV (e.g., an IoT device 704) furthest from the entrance is the smallest, the server 310 (e.g., the processor 422) may determine a normal situation. In the occurrence of the door opening event, when the amplitude of the first sound signal is smaller than the amplitude of the second sound signal, the server 310 (e.g., the processor 422) may detect an abnormal situation.

For example, when the door opening event has occurred but the sound information does not include the amplitude of the first sound signal (e.g., the AI speaker does not detect a sound), the server 310 (e.g., the processor 422) may determine that an abnormal situation has occurred due to door failure or a ghost command.

For example, when the door opening event has occurred but the amplitude of a sound signal recorded by another IoT device (e.g., a refrigerator located in a kitchen), which is not included in the related device list (e.g. the AI speaker, the TV, and the wireless charger), is included in the sound information, the server 310 (e.g., the processor 422) may determine that an abnormal situation has occurred.

FIG. 11 is a flowchart illustrating a sound-based anomaly monitoring procedure according to an embodiment. According to an embodiment, at least one of the following operations may be performed by the processor 422 of the server 310. Depending on embodiments, at least one of the following operations may be omitted, modified, or performed in a different order.

Referring to FIG. 11, in operation 1105, the server 310 (e.g., the processor 422) may identify occurrence of an event (e.g., a door opening event), based on state information (e.g., the state information received in operation 905). When no event has occurred, the server 310 (e.g., the processor 422) may return to operation 1105. In operation 1110, the server 310 (e.g., the processor 422) may identify an out-of-home situation, based on the state information. In in-home situation, which is opposite to the out-of-home situation, the server 310 (e.g., the processor 422) may return to operation 1105. In the out-of-home situation, the server 310 (e.g., the processor 422) may perform operation 1115.

In operation 1115, the server 310 (e.g., the processor 422) may analyze sound information (e.g., the sound information received in operation 905). In operation 1120, the server 310 (e.g., the processor 422) may determine whether the sound information includes the amplitude of at least one sound signal. When the sound information does not include the amplitude of any sound signal, the server 310 (e.g., the processor 422) may perform operation 1140. When the sound information includes the amplitude of at least one sound signal, the server 310 (e.g., the processor 422) may perform operation 1125.

In operation 1125, the server 310 (e.g., the processor 422) may determine, based on the sound information, whether the amplitude of a short-range sound signal (e.g., a near field sound) (e.g., a sound signal recorded by an AI speaker) related to the door opening event is greater than the amplitude of a long-range sound signal (e.g., a far field sound) (e.g., a sound signal recorded by a TV) related to the door opening event. In an embodiment, the sound information may include the amplitude of a first sound signal recorded by the AI speaker and the amplitude of a second sound signal recorded by the TV. In an embodiment, the server 310 (e.g., the processor 422) may identify that the first sound signal is the short-range sound signal and the second sound signal is the long-range sound signal, based on management data generated through the learning-based modeling. When the amplitude of the short-range sound signal is greater than the amplitude of the long-range sound signal, the server 310 (e.g., the processor 422) may perform operation 1130. When the amplitude of the short-range sound signal is not greater than the amplitude of the long-range sound signal, the server 310 (e.g., the processor 422) may perform operation 1140.

In operation 1130, the server 310 (e.g., the processor 422) may determine whether there is a different sound signal (e.g., a sound signal not related to the door opening event), based on the sound information. In an embodiment, when the sound information includes the amplitude of a third sound signal recorded by an IoT device (e.g., a refrigerator) that is far from a door lock, the server 310 (e.g., the processor 422) may determine that there is a different sound signal. As a result of the determination, when the different sound signal exists, the server 310 (e.g., the processor 422) may perform operation 1140. When a different sound signal does not exist, the server 310 (e.g., the processor 422) may perform operation 1135.

In operation 1135, the server 310 (e.g., the processor 422) may determine that an abnormal situation has not occurred in an area (e.g., home) corresponding to a network 300, for example, may determine a normal situation, and may terminate the procedure.

In operation 1140, the server 310 (e.g., the processor 422) may determine that an abnormal situation has occurred in the area (e.g., home) corresponding to the network 300. The abnormal situation (e.g., an abnormal event) detected as a result of anomaly monitoring may be stored in memory 426 of the server 310, notified to a user (e.g., an electronic device 201 and/or a computer device connected to a user account), or reported to a related system operator (e.g., a security system operator).

According to an embodiment, at least one of the operations of FIG. 10 and FIG. 11 may be performed by a processor 404 of the hub device 330.

According to embodiments, sound-based anomaly monitoring for identifying whether sound information corresponds to an event reported by state information may be as follows.

In an embodiment, the server 310 may identify a door opening event, based on state information in an out-of-home situation, and may determine a normal situation when identifying, based on sound information, that an IoT device closest to an entrance (e.g., an AI speaker located in a living room) detects the greatest sound signal and an IoT device (e.g., a TV) farthest from the entrance detects the smallest sound signal.

In an embodiment, the server 310 may identify that no event occurs, based on state information, and may determine an abnormal situation to report an abnormal event (e.g., door lock failure or a ghost command) to a user when identifying, based on sound information, that at least one related IoT device (e.g., an AI speaker close to an entrance) detects a sound signal.

In an embodiment, the server 310 may identify that an air sensor detects a purification event, based on state information, and may determine an abnormal situation to report an abnormal event (e.g., air purifier failure) to the user when identifying, based on sound information, that at least one related IoT device (e.g., a TV located in the same space (e.g., a living room) as an air purifier) fails to detect a sound signal including an operating sound of the air purifier.

In an embodiment, the server 310 may identify that a temperature sensor detects a high temperature (e.g., an internal temperature exceeding a designated threshold value), based on state information, and may determine an abnormal situation to report an abnormal event (e.g., air conditioner failure) to the user when identifying, based on sound information, that at least one related IoT device (e.g., a TV located in the same space (e.g., a living room) as an air conditioner) fails to detect a sound signal.

In an embodiment, the server 310 may identify that a gas sensor detects a gas leak event, based on state information, and may determine an abnormal situation to report an abnormal event (e.g., gas alarm failure) to the user when identifying, based on sound information, that at least one related IoT device (e.g., a refrigerator located in the same space as an gas alarm) fails to detect a sound signal.

In an embodiment, the server 310 may identify that an AI speaker is performing an operation, based on state information, and may determine an abnormal situation to report an abnormal event (e.g., a situation in which a laser or ultrasound-based AI adversarial attack is suspected) to the user when identifying, based on sound information, that at least one related IoT device (e.g., an AI speaker) fails to detect a sound signal.

In an embodiment, the server 310 may identify an out-of-home situation, based on state information, and may determine an abnormal situation to report an abnormal event (e.g., a situation in which an outsider is suspected of trespassing) to the user when identifying, based on user information, that at least one IoT device detects at least one sound signal (e.g., a human voice, a living noise, and a door/sideboard opening or closing sound).

In an embodiment, the server 310 may track the location and moving path of a robot vacuum cleaner including a camera, based on state information and/or sound information. In an embodiment, the server 310 may identify the location and moving path of the robot vacuum cleaner by analyzing a camera image recorded by the robot vacuum cleaner and/or the amplitude of a sound signal recorded by at least one IoT device. The server 310 may identify that no event occurs, based on the state information, and may determine an abnormal situation to report an abnormal event (e.g., hacking into the robot vacuum cleaner by an outsider attacker or robot vacuum cleaner failure) to the user when identifying that the identified moving path of the robot vacuum cleaner is different from a moving path designated by the user or a previously stored moving path or that the robot vacuum cleaner operates in an unspecified time.

An electronic device 310 according to an embodiment may include memory 426 storing instructions, a communication circuit 424, and a processor 422 operatively connected with the memory and the communication circuit and configured to execute the instructions. The instructions may cause the electronic device to obtain state information collected by at least one first Internet of Things (IoT) device and sound information including an amplitude of at least one sound signal collected by at least one second IoT device. The instructions may cause the electronic device to perform first anomaly monitoring, based on a correlation between the state information and the sound information. The instructions may cause the electronic device to perform second anomaly monitoring, based on the state information.

In an embodiment, the instructions may cause the electronic device to detect a first event, based on the state information, determine whether there is at least one first sound signal related to the first event, based on the sound information, and determine that an abnormal situation is detected based on identifying that the at least one first sound signal related to the first event does not exist.

In an embodiment, the instructions may cause the electronic device to determine whether a first amplitude of the at least one first sound signal is within a designated range based on the at least one first sound signal related to the first event existing, and determine that an abnormal situation is detected based on identifying that the first amplitude of the at least one first sound signal being out of the designated range.

In an embodiment, the instructions may cause the electronic device to detect a second event, based on the state information, determine whether at least one second sound signal exists, wherein the at least one second sound signal is not related to the second event, based on the sound information, and determine that an abnormal situation is detected based on the at least one second sound signal existing.

In an embodiment, the instructions may cause the electronic device to detect, based on the state information, the second event related to the at least one first IoT device; identify, based on the sound information, a third amplitude of a third sound signal and a fourth amplitude of a fourth sound signal, wherein both of the third sound signal and the fourth sound signal are related to the first IoT device; and, based on identifying that the third amplitude of the third sound signal is not greater than the fourth amplitude of the fourth sound signal, determine that an abnormal situation is detected.

In an embodiment, the sound information may be received from an external electronic device 330 through the communication circuit in an out-of-home situation in which there is no registered user in a designated area.

In an embodiment, the instructions may cause the electronic device to perform the first anomaly monitoring based on management data comprising at least one of an event identifier, a related device list, or a sound level per device.

In an embodiment, the management data may be generated based on the state information and the sound information collected in a designated training period.

In an embodiment, the state information may include at least one event indicating at least one of a bulb on/off, a robot vacuum cleaner on/off, a door lock on/off, or a window on/off.

In an embodiment, the sound information may include a device ID and an amplitude of a sound signal recorded by an IoT device corresponding to the device ID.

A method performed by an electronic device 310 according to an embodiment may include obtaining (505) state information collected by at least one first IoT device and sound information including an amplitude of at least one sound signal collected by at least one second IoT device. The method may include performing (510) first anomaly monitoring, based on a correlation between the state information and the sound information. The method may include performing (515) second anomaly monitoring, based on the state information.

In an embodiment, the first anomaly monitoring may include detecting a first event based on the state information, determining whether at least one first sound signal related to the first event exists based on the sound information, and determining that an abnormal situation is detected based on identifying that the at least one first sound signal related to the first event does not exist.

In an embodiment, the first anomaly monitoring may include determining whether a first amplitude of the at least one first sound signal is within a designated range based on the at least one first sound signal related to the first event existing, and determining that an abnormal situation is detected based on identifying that the first amplitude of the at least one first sound signal is out of the designated range.

In an embodiment, the first anomaly monitoring may include detecting a second event based on the state information, determining whether at least one second sound signal exists based on the sound information, wherein the at least one second sound signal is not related to the second event, and determining that an abnormal situation is detected based on the at least one second sound signal existing.

In an embodiment, the first anomaly monitoring may include detecting, based on the state information, the second event related to the at least one first IoT device; identifying, based on the sound information, a third amplitude of a third sound signal and a fourth amplitude of a fourth sound signal, wherein both of the third sound signal and the fourth sound signal are related to the at least one first IoT device; and, based on identifying that the third amplitude of the third sound signal is not greater than the fourth amplitude of the fourth sound signal, determining that an abnormal situation is detected.

In an embodiment, the method may further include receiving the sound information from an external electronic device 330 in an out-of-home situation in which there is no registered user in a designated area.

In an embodiment, the first anomaly monitoring may be performed based on management data comprising at least one of an event identifier, a related device list, or a sound level for each device.

In an embodiment, the method may further include generating the management data based on the state information and the sound information collected in a designated training period.

In an embodiment, the state information may include at least one event indicating at least one of a bulb on/off, a robot vacuum cleaner on/off, a door lock on/off, or a window on/off.

In an embodiment, the sound information may include a device ID and an amplitude of a sound signal recorded by an IoT device corresponding to the device ID.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory storing instructions;
a communication circuit; and
a processor operatively connected with the memory and the communication circuit, and configured to execute the instructions that cause the electronic device to:
obtain state information collected by at least one first Internet of Things (IoT) device and sound information comprising an amplitude of at least one sound signal collected by at least one second IoT device;
perform first anomaly monitoring, based on a correlation between the state information and the sound information; and
perform second anomaly monitoring, based on the state information.

2. The electronic device of claim 1, wherein the instructions cause the electronic device to:
detect a first event based on the state information;
determine whether at least one first sound signal related to the first event exists, based on the sound information; and
based on identifying that the at least one first sound signal related to the first event does not exist, determine that an abnormal situation is detected.

3. The electronic device of claim 2, wherein the instructions cause the electronic device to:
determine whether a first amplitude of the at least one first sound signal is within a designated range based on the at least one first sound signal related to the first event existing; and
based on identifying that the first amplitude of the at least one first sound signal is out of the designated range, determine that an abnormal situation is detected.

4. The electronic device of claim 1, wherein the instructions cause the electronic device to:
detect a second event, based on the state information;
based on the sound information, determine whether at least one second sound signal exists, wherein the at least one second sound signal is not related to the second event; and
based on the at least one second sound signal existing, determine that an abnormal situation is detected.

5. The electronic device of claim 1, wherein the instructions cause the electronic device to:
detect the second event related to the at least one first IoT device, based on the state information;
based on the sound information, identify a third amplitude of a third sound signal and a fourth amplitude of a fourth sound signal, wherein both of the third sound signal and the fourth sound signal are related to the at least one first IoT device; and
based on identifying that the third amplitude of the third sound signal is not greater than the fourth amplitude of the fourth sound signal, determine that an abnormal situation is detected.

6. The electronic device of claim 1, wherein the sound information is received from an external electronic device through the communication circuit in an out-of-home situation in which there is no registered user in a designated area.

7. The electronic device of claim 1, wherein the instructions cause the electronic device to perform the first anomaly monitoring based on management data comprising at least one of an event identifier, a related device list, or a sound level per device.

8. The electronic device of claim 7, wherein the management data is generated based on the state information and the sound information collected in a designated training period.

9. The electronic device of claim 1, wherein the state information comprises at least one event indicating at least one of a bulb on/off, a robot vacuum cleaner on/off, a door lock on/off, or a window on/off.

10. The electronic device of claim 1, wherein the sound information comprises a device identification (ID) and an amplitude of a sound signal recorded by an IoT device corresponding to the device ID.

11. A method performed by an electronic device, the method comprising:
obtaining state information collected by at least one first Internet of Things (IoT) device and sound information comprising an amplitude of at least one sound signal collected by at least one second IoT device;
performing first anomaly monitoring, based on a correlation between the state information and the sound information; and
performing second anomaly monitoring, based on the state information.

12. The method of claim 11, wherein the first anomaly monitoring comprises:
detecting a first event based on the state information;
based on the sound information, determining whether at least one first sound signal related to the first event exists;
based on identifying that the at least one first sound signal related to the first event does not exist, determining that an abnormal situation is detected.

13. The method of claim 12, wherein the first anomaly monitoring comprises:
determining whether a first amplitude of the at least one first sound signal is within a designated range based on the at least one first sound signal related to the first event existing; and
based on identifying that the first amplitude of the at least one first sound signal is out of the designated range, determining that an abnormal situation is detected.

14. The method of claim 11, wherein the first anomaly monitoring comprises:
detecting a second event, based on the state information;
based on the sound information, determining whether at least one second sound signal exists, wherein the at least one second sound signal is not related to the second event;
based on the at least one second sound signal existing, determining that an abnormal situation is detected.

15. The method of claim 11, wherein the first anomaly monitoring comprises:
detecting the second event related to the at least one first IoT device, based on the state information;
based on the sound information, identifying a third amplitude of a third sound signal and a fourth amplitude of a fourth sound signal, wherein both of the third sound signal and the fourth sound signal are related to the at least one first IoT device; and
based on identifying that the third amplitude of the third sound signal is not greater than the fourth amplitude of the fourth sound signal, determining that an abnormal situation is detected.

16. The method of claim 11, further comprising:
receiving the sound information from an external electronic device in an out-of-home situation in which there is no registered user in a designated area.

17. The method of claim 11, wherein the first anomaly monitoring is performed based on management data comprising at least one of an event identifier, a related device list, or a sound level for per device.

18. The method of claim 17, further comprising generating the management data based on the state information and the sound information collected in a designated training period.

19. The method of claim 11, wherein the state information comprises at least one event indicating at least one of a bulb on/off, a robot vacuum cleaner on/off, a door lock on/off, or a window on/off.

20. The method of claim 11, wherein the sound information comprises a device identification (ID) and an amplitude of a sound signal recorded by an IoT device corresponding to the device ID.
